(19) United States
(12) Patent Application Publication
(10) Pub. No.: US 2013/0141419 A1
(43) Pub. Date: Jun. 6, 2013

(54) AUGMENTED REALITY WITH REALISTIC OCCLUSION

(71) Applicants: Brian Mount, Seattle, WA (US); Stephen Latta, Seattle, WA (US); Daniel McCulloch, Kirkland, WA (US); Kevin Geisner, Mercer Island, WA (US); Jason Scott, Kirkland, WA (US); Jonathan Steed, Redmond, WA (US); Arthur Tomlin, Bellevue, WA (US); Mark Mihelich, Seattle, WA (US)

(72) Inventors: Brian Mount, Seattle, WA (US); Stephen Latta, Seattle, WA (US); Daniel McCulloch, Kirkland, WA (US); Kevin Geisner, Mercer Island, WA (US); Jason Scott, Kirkland, WA (US); Jonathan Steed, Redmond, WA (US); Arthur Tomlin, Bellevue, WA (US); Mark Mihelich, Seattle, WA (US)

(21) Appl. No.: 13/309,372

(22) Filed: Dec. 1, 2011

(51) Int. Cl. G09G 5/377; G06T 15/00

(52) U.S. Cl. 345/419; 345/633

(57) ABSTRACT

A head-mounted display device is configured to visually augment an observed physical space to a user. The head-mounted display device includes a see-through display and is configured to receive augmented display information, such as a virtual object with occlusion relative to a real world object from a perspective of the see-through display.

### BACKGROUND

Virtual reality systems exist for simulating virtual environments within which a user may be immersed. Displays such as head-up displays, head-mounted displays, etc., may be utilized to display the virtual environment. Thus far, it has been difficult to provide totally immersive experiences to a virtual reality participant, especially when interacting with another virtual reality participant in the same virtual reality environment.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of the disclosure, a head-mounted display device is configured to visually augment an observed physical space to a user. The head-mounted display device includes a see-through display, and is configured to receive augmented display information, such as a virtual object with occlusion relative to a real world object from a perspective of the see-through display.

### BRIEF DESCRIPTION OF THE DRAWINGS

FIG. 1A schematically shows a top view of an example physical space including two users according to an embodiment of the present disclosure.

FIG. 1B shows a perspective view of a shared virtual reality environment from a perspective of one user of FIG. 1A.

FIG. 1C shows a perspective view of the shared virtual reality environment of FIG. 1B from a perspective of the other user of FIG. 1A.

FIG. 2A schematically shows a top view of a user in an example physical space according to an embodiment of the present disclosure.

FIG. 2B schematically shows a top view of another user in another example physical space according to an embodiment of the present disclosure.

FIG. 2C shows a perspective view of a shared virtual reality environment from a perspective of the user of FIG. 2A.

FIG. 2D shows a perspective view of the shared virtual reality environment of FIG. 2C from a perspective of the user of FIG. 2B.

FIG. 3 shows a flowchart illustrating an example method for augmenting reality according to an embodiment of the present disclosure.

FIG. 4A shows an example head mounted display according to an embodiment of the present disclosure.

FIG. 4B shows a user wearing the example head mounted display of FIG. 4A.

FIG. 5 schematically shows an example computing system according to an embodiment of the present disclosure.

### DETAILED DESCRIPTION

Virtual reality systems allow a user to become immersed to varying degrees in a simulated virtual environment. In order to render an immersive feeling, the virtual environment may be displayed to the user via a head-mounted display (HMD). Further, the HMD may include a see-through display, which may allow a user to see both virtual and real objects simultaneously. Since virtual and real objects may both be present in a virtual environment, overlapping issues between the real objects and the virtual objects may occur. In particular, real world objects may not appear to be properly hidden behind virtual objects and/or vice versa. The herein described systems and methods augment the virtual reality environment as displayed on the see-through display to overcome overlapping issues. For example, a virtual object positioned behind a real object may be occluded. As another example, a virtual object that blocks a view of a real object may have increased opacity to sufficiently block the view of the real object. Further, more than one user may participate in a shared virtual reality experience. Since each user may have a different perspective of the shared virtual reality experience, each user may have a different view of a virtual object and/or a real object, and such objects may be augmented via occlusion or adjusting opacity when overlapping occurs from either perspective.

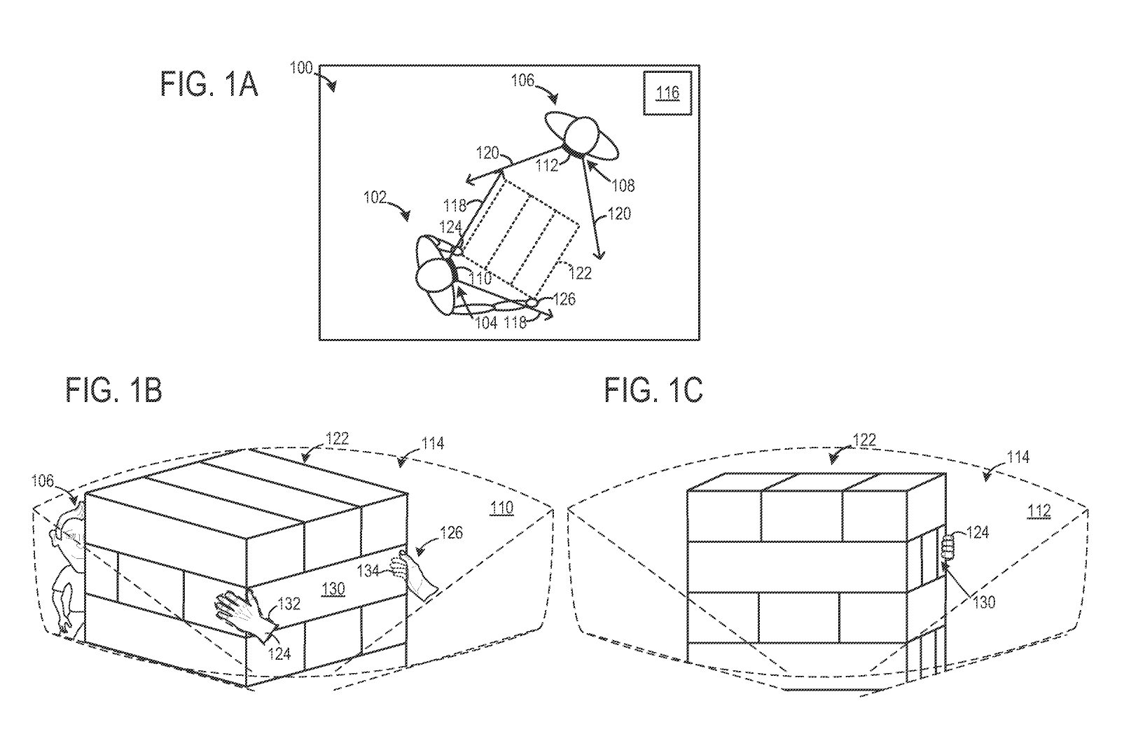

FIG. 1A shows an example physical space 100 including first user 102 wearing first head mounted display (HMD) device 104, and second user 106 wearing second HMD device 108. Each user may observe the same physical space 100 but from different perspectives. In other words, an HMD device of one user may observe the physical space from a different perspective than an HMD device of another user, yet the two observed physical spaces may be congruent. As such, the two observed physical spaces may be the same space, but viewed from different perspectives depending on the position and/or orientation of each HMD device within the congruent physical space.

HMD device 104 may include a first see-through display 110 configured to display a shared virtual reality environment to user 102. Further, see-through display 110 may be configured to visually augment an appearance of physical space 100 to user 102. In other words, see-through display 110 allows light from physical space 100 to pass through see-through display 110 so that user 102 can directly see the actual physical space 100, as opposed to seeing an image of the physical space on a conventional display device. Furthermore, see-through display 110 is configured to generate light and/or modulate light so as to display one or more virtual objects as an overlay to the actual physical space 100. In this way, see-through display 110 may be configured so that user 102 is able to view a real object in physical space through one or more partially transparent pixels that are displaying a virtual object. FIG. 1B shows see-through display 110 as seen from a perspective of user 102.

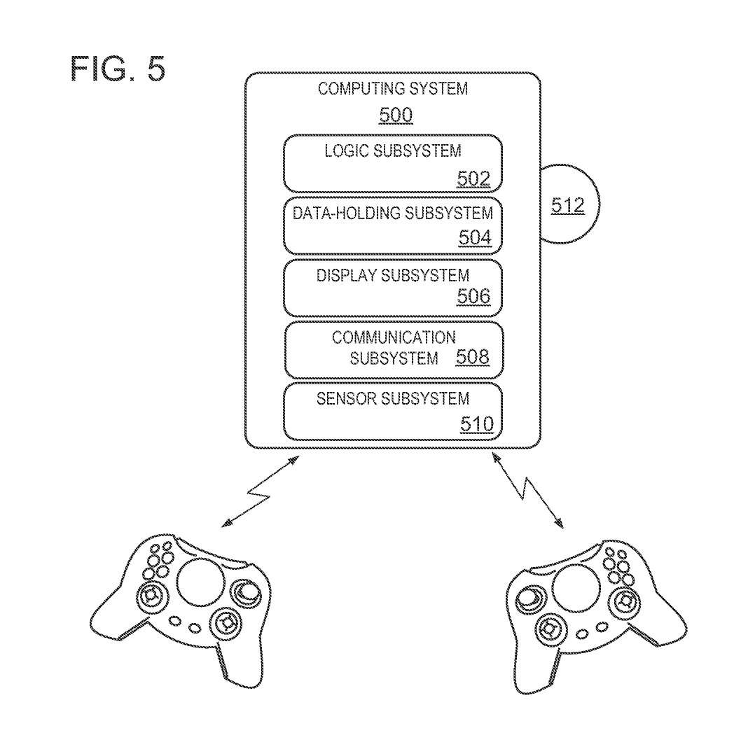

Likewise, HMD device 108 may include a second see-through display 112 configured to display the shared virtual reality environment to user 106. Similar to see-through display 110, see-through display 112 may be configured to visually augment the appearance of physical space 100 to user 106. In other words, see-through display 112 may display one or more virtual objects while allowing light from one or more real objects to pass through. In this way, see-through display 112 may be configured so that user 106 is able to view a real object in physical space through one or more partially transparent pixels that are displaying a virtual object. For example, FIG. 1C shows see-through display 112 as seen from a perspective of user 106. In general, HMD device 104 and HMD device 108 are computing systems and will be discussed in greater detail with respect to FIG. 5.

Further, a tracking system may monitor a position and/or orientation of HMD device 104 and HMD device 108 within physical space 100. The tracking system may be integral with each HMD device, and/or the tracking system may be a separate system, such as a component of computing system 116. A separate tracking system may track each HMD device by capturing images that include at least a portion of the HMD device and a portion of the surrounding physical space, for example. Further, such a tracking system may provide input to a three-dimensional (3D) modeling system.

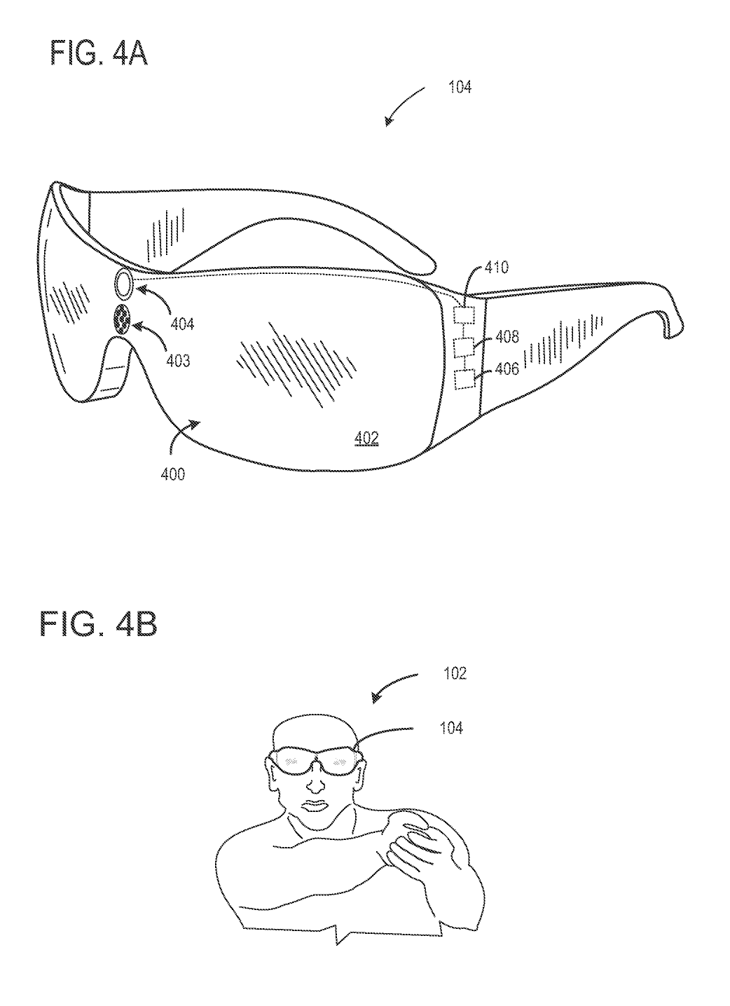

The 3D modeling system may build a 3D virtual reality environment based on at least one physical space, such as physical space 100. The 3D modeling system may be integral with each HMD device, and/or the 3D modeling system may be a separate system, such as a component of computing system 116. The 3D modeling system may receive a plurality of images from the tracking system, which may be compiled to generate a 3D map of physical space 100, for example. Once, the 3D map is generated, the tracking system may track the HMD devices with improved precision. In this way, the tracking system and the 3D modeling system may cooperate synergistically. The combination of position tracking and 3D modeling is often referred to as simultaneous localization and mapping (SLAM) to those skilled in the art. For example, SLAM may be used to build a shared virtual reality environment 114. The tracking system and the 3D modeling system will be discussed in more detail with respect to FIGS. 4A and 5.

Referring to FIGS. 1B and 1C, shared virtual reality environment 114 may be a virtual world that incorporates and/or builds off of one or more aspects observed by HMD device 104 and one or more aspects observed by HMD device 108. Thus, shared virtual reality environment 114 may be leveraged from a shared coordinate system that maps a coordinate system from the perspective of user 102 with a coordinate system from the perspective of user 106. For example, HMD device 104 may be configured to display shared virtual reality environment 114 by transforming a coordinate system of physical space 100 from the perspective of see-through display 110 to a coordinate system of physical space 100 from the perspective of see-through display 112. Likewise, HMD device 108 may be configured to display shared virtual reality environment 114 by transforming the coordinate system of physical space 100 from the perspective of see-through display 112 to the coordinate system of physical space 100 from the perspective of see-through display 110. It is to be understood that the native coordinate system of any HMD device may be mapped to the native coordinate system of another HMD device, or the native coordinate system of all HMD devices may be mapped to a neutral coordinate system.

Further, it is to be understood that the HMD device may be configured to display a virtual reality environment without transforming a native coordinate system. For example, user 102 may interact with the virtual reality environment without sharing the virtual reality environment with another user. In other words, user 102 may be a single player interacting with the virtual reality environment, thus the coordinate system may not be shared, and further, may not be transformed. Hence, the virtual reality environment may be solely presented from a single user's perspective. As such, a perspective view of the virtual reality environment may be displayed on a see-through display of the single user. Further, the display may occlude one or more virtual objects and/or one or more real objects based on the perspective of the single user without sharing such a perspective with another user, as described in more detail below.

As another example, shared virtual reality environment 114 may be leveraged from a previously mapped physical environment. For example, one or more maps may be stored such that the HMD device may access a particular stored map that is similar to a particular physical space. For example, one or more features of the particular physical space may be used to match the particular physical space to a stored map. Further, it will be appreciated that such a stored map may be augmented, and as such, the stored map may be used as a foundation from which to generate a 3D map for a current session. As such, real-time observations may be used to augment the stored map based on the perspective of a user wearing the HMD device, for example. Further still, it will be appreciated that such a stored pre-generated map may be used for occlusion, as described herein.

In this way, one or more virtual objects and/or one or more real objects may be mapped to a position within the shared virtual reality environment 114 based on the shared coordinate system. Therefore, users 102 and 106 may move within the shared virtual reality environment, and thus change perspectives, and a position of each object (virtual and/or real) may be shared to maintain the appropriate perspective for each user.

As shown in FIG. 1A, user 102 has a perspective view outlined by arrows 118. Further, user 106 has a perspective view outlined by arrows 120. Depending on the position of each user within physical space 100, the perspective view of each user may be different. For example, user 102 may ‘see’ a virtual object 122 from a different perspective than user 106, as shown.

Referring to FIG. 1B, see-through display 110 shows the perspective of user 102 interacting with shared virtual reality environment 114. See-through display 110 displays virtual object 122, a real left hand 124 of user 102, a real right hand 126 of user 102, and user 106.

Virtual object 122 is an object that exists within shared virtual reality environment 114 but does not actually exist within physical space 100. It will be appreciated that virtual object 122 is drawn with dashed lines in FIG. 1A to indicate a position of virtual object 122 relative to users 102 and 106; however, virtual object 122 is not actually present in physical space 100.

Virtual object 122 is a stack of alternating layers of virtual blocks, as shown. Therefore, virtual object 122 includes a plurality of virtual blocks, each of which may also be referred to herein as a virtual object. For example, user 102 and user 106 may be playing a block stacking game, in which blocks may be moved and relocated to a top of the stack. Such a game may have an objective to reposition the virtual blocks while maintaining structural integrity of the stack, for example. In this way, user 102 and user 106 may interact with the virtual blocks within shared virtual reality environment 114.

It will be appreciated that virtual object 122 is shown as a stack of blocks by way of example, and thus, is not meant to be limiting. As such, a virtual object may take on a form of virtually any object without departing from the scope of this disclosure.

As shown, real left hand 124 of user 102, and real right hand 126 of user 102 are visible through see-through display 110. The real left and right hands are examples of real objects because these objects physically exist within physical space 100, as indicated in FIG. 1A. It is to be understood that the arms to which the hands are attached may also be visible, but are not included in FIG. 1B. Further, other real objects such as a leg, a knee, and/or a foot of a user may be visible through see-through display 110. It will be appreciated that virtually any real object, whether animate or inanimate, may be visible through the see-through display.

Real left hand 124 includes a portion that has a mapped position between first see-through display 110 and a virtual block 130. As such, see-through display 110 displays images such that a portion of virtual block 130 that overlaps with real left hand 124 from the perspective of see-through display 110 appears to be occluded by real left hand 124. In other words, only those portions of virtual block 130 that are not behind the real left hand 124 from the perspective of see-through display 110 are displayed by the see-through display 110. For example, portion 132 of virtual block 130 is occluded (i.e., not displayed) because portion 132 is blocked by real left hand 124 from the perspective of first see-through display 110.

Real right hand 126 includes a portion 134 that has a mapped position behind virtual block 130. As such, a portion of virtual block 130 has a mapped position that is between portion 134 of real right hand 126 and see-through display 110. As such, see-through display 110 displays images such that portion 134 appears to be occluded by block 130. Said in another way, first see-through display 110 may be configured to display the corresponding portion of virtual block 130 with sufficient opacity so as to substantially block sight of portion 134. In this way, user 102 may see only those portions of real right hand 126 that are not blocked by virtual block 130.

Furthermore, those portions of user 106 that are not occluded by virtual object 122 are also visible through see-through display 110. However, in some embodiments, a virtual representation, such as an avatar, of another user may be superimposed over the other user. For example, an avatar may be displayed with sufficient opacity so as to virtually occlude user 106. As another example, see-through display 110 may display a virtual enhancement that augments the appearance of user 106.

FIG. 1C shows see-through display 112 from the perspective of user 106 interacting with shared virtual reality environment 114. See-through display 112 displays virtual objects and/or real objects, similar to see-through display 110. However, a perspective view of some objects may be different due to the particular perspective of second user 106 viewing shared virtual reality environment 114 through HMD device 108.

Briefly, see-through display 112 displays virtual object 122 and real left hand 124 of user 102. As shown, the perspective view of virtual object 122 displayed on second see-through display 112 is different than the perspective view of virtual object 122 as shown in FIG. 1B. In particular, user 106 sees a different side of virtual object 122 than user 102 sees.

As shown, real left hand 124 grasps virtual block 130, and user 106 sees real left hand 124 in actual physical form through see-through display 112. See-through display 112 may be configured to display virtual object 122 with sufficient opacity so as to substantially block sight of all but a portion of left hand 124 from the perspective of see-through display 112. As such, only those portions of user 102 which are not blocked by virtual object 122 from the perspective of user 106 will be visible, as shown. It will be appreciated that the left hand of user 102 may be displayed as a virtual hand, in some embodiments.

It will be appreciated that second see-through display 112 may display additional and/or alternative features than those shown in FIG. 1C. For example, user 106 may extend real hands, which may be visible through second see-through display 112. Further, the arms of user 106 may also be visible.

In the depicted example, user 106 is standing with hands lowered as if waiting for user 102 to complete a turn. Thus, it will be appreciated that user 106 may perform similar gestures as user 102, and similar occlusion of virtual objects and/or increasing opacity to block real objects may be applied without departing from the scope of this disclosure.

Referring back to FIG. 1A, FIG. 1A also schematically shows a computing system 116. Computing system 116 may be used to play a variety of different games, play one or more different media types, and/or control or manipulate non-game applications and/or operating systems. Computing system 116 may wirelessly communicate with HMD devices to present game or other visuals to users. Such a computing system will be discussed in greater detail with respect to FIG. 5. It is to be understood that HMD devices need not communicate with an off-board computing device in all embodiments.

It will be appreciated that FIGS. 1A-1C are provided by way of example, and thus are not meant to be limiting. Further, it is to be understood that some features may be omitted from the illustrative embodiment without departing from the scope of this disclosure. For example, computing system 116 may be omitted, and first and second HMD devices may be configured to leverage the shared coordinate system to build the shared virtual reality environment without computing system 116.

Further, it will be appreciated that FIGS. 1A-1C show a block stacking virtual reality game as an example to illustrate a general concept. Thus, it will be appreciated that other games and non-game applications are possible without departing from the scope of this disclosure. Further, it is to be understood that physical space 100 and corresponding shared virtual reality environment 114 may include additional and/or alternative features than those shown in FIGS. 1A-1C. For example, physical space 100 may optionally include one or more playspace cameras placed at various locations within physical space 100. Such cameras may provide additional input for determining a position of a user, a position of one or more HMD devices, and/or a position of a real object, for example. Further, physical space 100 may be virtually any type of physical space, and thus, is not limited to a room, as illustrated in FIG. 1A. For example, the physical space may be another indoor space, an outdoor space, or virtually any other space. Further, in some embodiments the perspective of the first user may observe a different physical space than the perspective of the second user, yet the different physical spaces may contribute to a shared virtual reality environment.

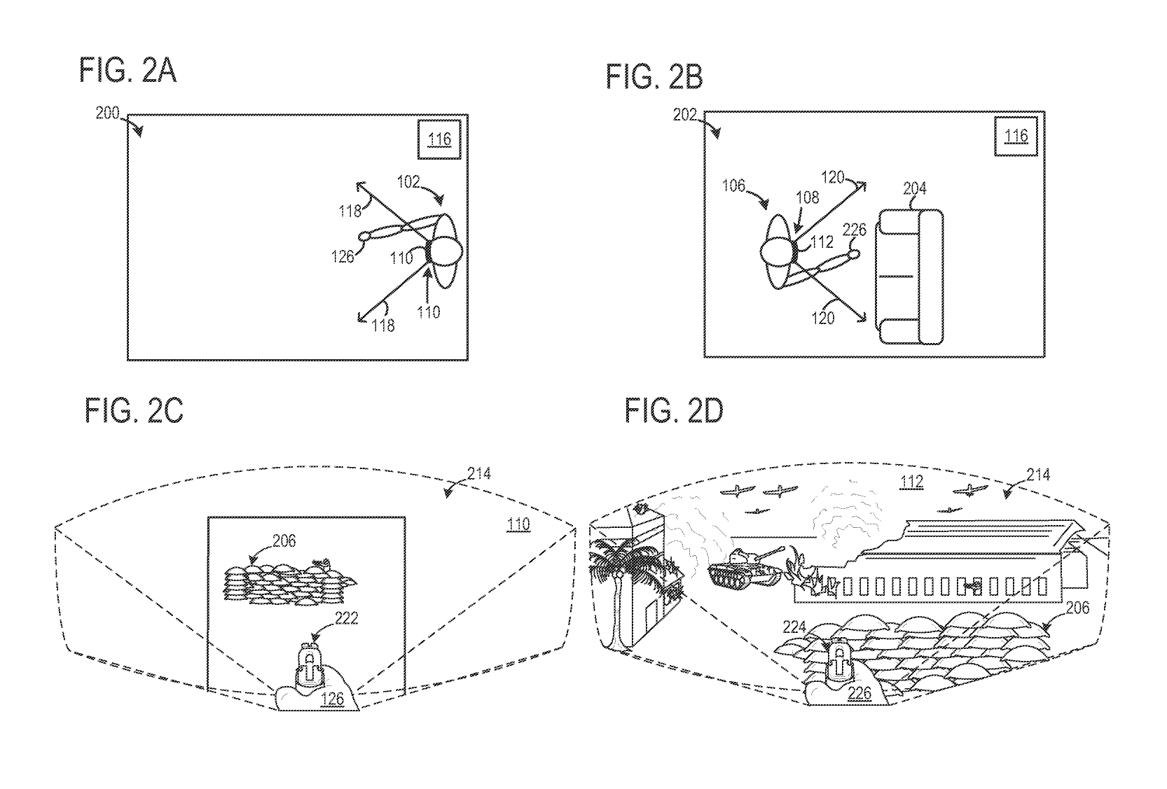

For example, FIGS. 2A and 2B show an example first physical space 200 and an example second physical space 202, respectively. Physical space 200 may be in a different physical location than physical space 202. Thus, physical space 200 and physical space 202 may be incongruent. It will be appreciated that FIGS. 2A and 2B include similar features as FIG. 1A, and such features are indicated with like numbers. For the sake of brevity, such features will not be discussed repetitively.

Briefly, as shown in FIG. 2A, physical space 200 includes user 102 wearing HMD device 104, which includes see-through display 110. Further, HMD device 104 observes physical space 200 from a perspective as outlined by arrows 118. Such a perspective is provided as input to shared virtual reality environment 214, similar to the above description.

As shown in FIG. 2B, physical space 202 includes user 106 wearing HMD device 108, which includes see-through display 112. Further, HMD device 108 observes physical space 202 from a perspective as outlined by arrows 120. Such a perspective is also provided as input to the shared coordinate system of shared virtual reality environment 214, similar to the above description.

FIG. 2C shows a perspective view of shared virtual reality environment 214 as seen through see-through display 110. As shown, real hand 126 interacts with virtual object 222, which is illustrated in FIG. 2C as a handgun by way of example. As described above, a portion of virtual object 222 is occluded when real hand 126 is positioned between see-through display 110 and virtual object 222. Further, another portion of virtual object 222 has sufficient opacity to block a portion of real hand 126 that is positioned behind virtual object 222, as described above.

FIG. 2D shows a perspective view of shared virtual reality environment 214 as seen through see-through display 112. As shown, a real hand 226 of user 106 interacts with virtual object 224, which is illustrated in FIG. 2D as a handgun by way of example. It will be appreciated that real hand 226 may interact with virtual object 224 similar to real hand 126 and virtual object 224.

Turning back to FIG. 2B, physical space 202 includes a real object 204, and further, such an object is not actually present within physical space 200. Therefore, real object 204 is physically present within physical space 202 but not physically present within physical space 200. As shown, real object 204 is a couch.

Referring to FIGS. 2B and 2D, real object 204 is incorporated into shared virtual reality environment 214 as a surface reconstructed object 206. Therefore, real object 204 is transformed to surface reconstructed object 206, which is an example of a virtual object. In particular, a shape of real object 204 is used to render a similar shaped surface reconstructed object 206. As shown, surface reconstructed object 206 is a pile of sandbags.

Further, since surface reconstructed object 206 is transformed from real object 204 within physical space 202, it has an originating position with respect to the coordinate system from the perspective of user 106. Therefore, coordinates of such an originating position are transformed to the coordinate system from the perspective of user 102. In this way, the shared coordinate system maps a position of surface reconstructed object 206 using the originating position as a reference point. Therefore, both users can interact with surface reconstructed object 206 even though real object 204 is only physically present within physical space 202.

As shown in FIGS. 2C and 2D, a perspective view of surface reconstructed object 206 is different between see-through display 110 and see-through display 112. In other words, each user sees a different side of surface reconstructed object 206.

FIGS. 2A-2D show a combat virtual reality game as an example to illustrate a general concept. Other games, and non-game applications are possible without departing from the scope of this disclosure. Further, it is to be understood that physical spaces 200 and 202 and corresponding shared virtual reality environment 214 may include additional and/or alternative features than those shown in FIGS. 2A-2D. For example, physical space 200 and/or physical space 202 may optionally include one or more playspace cameras. Further, the physical spaces are not limited to the rooms illustrated in FIGS. 2A and 2B. For example, each physical space may be another indoor space, an outdoor space, or virtually any other space.

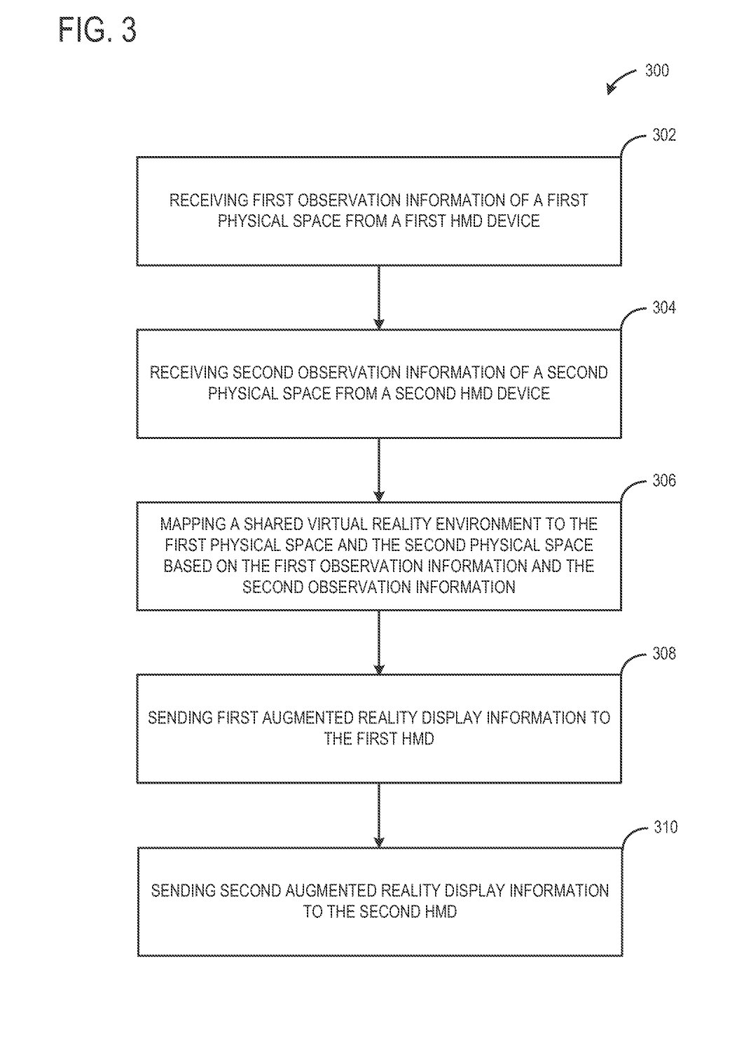

FIG. 3 illustrates an example method 300 for augmenting reality. For example, a virtual object and/or a real object displayed on a see-through display may be augmented depending on a position of such an object in a shared virtual reality environment and a perspective of a user wearing an HMD device, as described above.

At 302, method 300 includes receiving first observation information of a first physical space from a first HMD device. For example, the first HMD device may include a first see-through display configured to visually augment an appearance of the first physical space to a user viewing the first physical space through the first see-through display. Further, a sensor subsystem of the first HMD device may collect the first observation information. For example, the sensor subsystem may include a depth camera and/or a visible light camera imaging the first physical space. Further, the sensor subsystem may include an accelerometer, a gyroscope, and/or another position or orientation sensor.

At 304, method 300 includes receiving second observation information of a second physical space from a second HMD device. For example, the second HMD device may include a second see-through display configured to visually augment an appearance of the second physical space to a user viewing the second physical space through the second see-through display. Further, a sensor subsystem of the second HMD device may collect the second observation information.

As one example, the first physical space and the second physical space may be congruent, as described above with respect to FIGS. 1A-1C. In other words, the first physical space may be the same as the second physical space; however, the first observation information and the second observation information may represent different perspectives of the same physical space. For example, the first observation information may be from a first perspective of the first see-through display and the second observation information may be from a second perspective of the second see-through display, wherein the first perspective is different from the second perspective.

As another example, the first physical space and the second physical space may be incongruent, as described above with respect to FIGS. 2A-2D. In other words, the first physical space may be different than the second physical space. For example, a user of the first HMD device may be located in a different physical space than a user of the second HMD device; however, the two users may have a shared virtual experience where both users interact with the same virtual reality environment.

At 306, method 300 includes mapping a shared virtual reality environment to the first physical space and the second physical space based on the first observation information and the second observation information. For example, mapping the shared virtual reality environment may include transforming a coordinate system of the first physical space from the perspective of the first see-through display and/or a coordinate system of the second physical space from a perspective of the second see-through display to a shared coordinate system. Further, mapping the shared virtual reality environment may include transforming the coordinate system of the second physical space from the perspective of the second see-through display to the coordinate system of the first physical space from the perspective of the first see-through device or to a neutral coordinate system. In other words, the coordinate systems of the perspectives of the first and second see-through displays may be aligned to share the shared coordinate system.

As described above, the shared virtual reality environment may include a virtual object, such as an avatar, a surface reconstructed real object, and/or another virtual object. Further, the shared virtual reality environment may include a real object, such as a real user wearing one of the HMD devices, and/or a real hand of the real user. Virtual objects and real objects are mapped to the shared coordinate system.

Further, when the shared virtual reality environment is leveraged from observing congruent first and second physical spaces, the shared virtual reality environment may be mapped such that the virtual object appears to be located in a same physical space from both the first perspective and the second perspective.

Further, when the shared virtual reality environment is leveraged from observing incongruent first and second physical spaces, the shared virtual reality environment may include a mapped second real world object that is physically present in the second physical space but not physically present in the first physical space. Therefore, the second real world object may be represented in the shared virtual reality environment such that the second real world object is visible through the second see-through display, and the second real world object is displayed as a virtual object through the first see-through display, for example. As another example, the second real world object may be included as a surface reconstructed object, which may be displayed by both the first and second see-through displays, for example.

At 308, method 300 includes sending first augmented reality display information to the first HMD device. For example, the first augmented reality display information may include the virtual object via the first see-through display with occlusion relative to the real world object from the perspective of the first see-through display. The shared augmented reality display information may be sent from one component of an HMD device to another component of an HMD device, or from an off-board computing device or other HMD device to an HMD device.

Further, the first augmented reality display information may be configured to display only those portions of the virtual object that are not behind the real world object from the perspective of the first see-through display. As another example, the first augmented display information may be configured to display the virtual object with sufficient opacity so as to substantially block sight of the real world object through the first see-through display. As used herein, the augmented reality display information is so configured if it causes the HMD device to occlude real or virtual objects as indicated.

At 310, method 300 includes sending second augmented reality display information to the second HMD device. For example, the second augmented reality display information may include the virtual object via the second see-through display with occlusion relative to the real world object from a perspective of the second see-through display.

It will be appreciated that method 300 is provided by way of example, and thus, is not meant to be limiting. Therefore, method 300 may include additional and/or alternative steps than those illustrated in FIG. 3. Further, one or more steps of method 300 may be omitted or performed in a different order without departing from the scope of this disclosure.

FIG. 4A shows an example HMD device, such as HMD device 104 and HMD device 108. The HMD device takes the form of a pair of wearable glasses, as shown. For example, FIG. 4B shows a user, such as first user 102 or user 106 wearing the HMD device. In some embodiments, the HMD device may have another suitable form in which a see-through display system is supported in front of a viewer's eye or eyes.

The HMD device includes various sensors and output devices. As shown, the HMD device includes a see-through display subsystem 400, such that images may be delivered to the eyes of a user. As one nonlimiting example, the display subsystem 400 may include image-producing elements (e.g. see-through OLED displays) located within lenses 402. As another example, the display subsystem may include a light modulator on an edge of the lenses, and the lenses may serve as a light guide for delivering light from the light modulator to the eyes of a user. Because the lenses 402 are at least partially transparent, light may pass through the lenses to the eyes of a user, thus allowing the user to see through the lenses.

The HMD device also includes one or more image sensors. For example, the HMD device may include at least one inward facing sensor 403 and/or at least one outward facing sensor 404. Inward facing sensor 403 may be an eye tracking image sensor configured to acquire image data to allow a viewer's eyes to be tracked.

Outward facing sensor 404 may detect gesture-based user inputs. For example, outwardly facing sensor 404 may include a depth camera, a visible light camera, an infrared light camera, or another position tracking camera. Further, such outwardly facing cameras may have a stereo configuration. For example, the HMD device may include two depth cameras to observe the physical space in stereo from two different angles of the user's perspective. In some embodiments, gesture-based user inputs also may be detected via one or more playspace cameras, while in other embodiments gesture-based inputs may not be utilized. Further, outward facing image sensor 404 may capture images of a physical space, which may be provided as input to a 3D modeling system. As described above, such a system may be used to generate a 3D model of the physical space. In some embodiments, the HMD device may include an infrared projector to assist in structured light and/or time of flight depth analysis. For example, the HMD device may include more than one sensor system to generate the 3D model of the physical space. In some embodiments, the HMD device may include depth sensing via a depth camera as well as light imaging via an image sensor that includes visible light and/or infrared light imaging capabilities.

The HMD device may also include one or more motion sensors 408 to detect movements of a viewer's head when the viewer is wearing the HMD device. Motion sensors 408 may output motion data for provision to computing system 116 for tracking viewer head motion and eye orientation, for example. As such motion data may facilitate detection of tilts of the user's head along roll, pitch and/or yaw axes, such data also may be referred to as orientation data. Further, motion sensors 208 may enable position tracking of the HMD device to determine a position of the HMD device within a physical space. Likewise, motion sensors 408 may also be employed as user input devices, such that a user may interact with the HMD device via gestures of the neck and head, or even of the body. Non-limiting examples of motion sensors include an accelerometer, a gyroscope, a compass, and an orientation sensor, which may be included as any combination or subcombination thereof. Further, the HMD device may be configured with global positioning system (GPS) capabilities.

It will be understood that the sensors illustrated in FIG. 4A are shown by way of example and thus are not intended to be limiting in any manner, as any other suitable sensors and/or combination of sensors may be utilized.

The HMD device may also include one or more microphones 406 to allow the use of voice commands as user inputs. Additionally or alternatively, one or more microphones separate from the HMD device may be used to detect viewer voice commands.

The HMD device may include a controller 410 having a logic subsystem and a data-holding subsystem in communication with the various input and output devices of the HMD device, which are discussed in more detail below with respect to FIG. 5. Briefly, the data-holding subsystem may include instructions that are executable by the logic subsystem, for example, to receive and forward inputs from the sensors to computing system 116 (in unprocessed or processed form) via a communications subsystem, and to present such images to the viewer via the see-through display subsystem 400. Audio may be presented via one or more speakers on the HMD device, or via another audio output within the physical space.

It will be appreciated that the HMD device is provided by way of example, and thus is not meant to be limiting. Therefore it is to be understood that the HMD device may include additional and/or alternative sensors, cameras, microphones, input devices, output devices, etc. than those shown without departing from the scope of this disclosure. Further, the physical configuration of an HMD device and its various sensors and subcomponents may take a variety of different forms without departing from the scope of this disclosure.

In some embodiments, the above described methods and processes may be tied to a computing system including one or more computers. In particular, the methods and processes described herein may be implemented as a computer application, computer service, computer API, computer library, and/or other computer program product.

FIG. 5 schematically shows a non-limiting computing system 500 that may perform one or more of the above described methods and processes. For example, HMD devices 104 and 108 may be a computing system, such as computing system 500. As another example, computing system 500 may be a computing system 116, separate from HMD devices 104 and 108, but communicatively coupled to each HMD device. Computing system 500 is shown in simplified form. It is to be understood that virtually any computer architecture may be used without departing from the scope of this disclosure.

Computing system 500 includes a logic subsystem 502 and a data-holding subsystem 504. Computing system 500 may optionally include a display subsystem 506, a communication subsystem 508, a sensor subsystem 510, and/or other components not shown in FIG. 5. Computing system 500 may also optionally include user input devices such as keyboards, mice, game controllers, cameras, microphones, and/or touch screens, for example.

Logic subsystem 502 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 504 may include one or more physical, non-transitory, devices configured to hold data and/or instructions executable by the logic subsystem to implement the herein described methods and processes. When such methods and processes are implemented, the state of data-holding subsystem 504 may be transformed (e.g., to hold different data).

Data-holding subsystem 504 may include removable media and/or built-in devices. Data-holding subsystem 504 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 504 may include devices with one or more of the following characteristics: volatile, nonvolatile, dynamic, static, read/write, read-only, random access, sequential access, location addressable, file addressable, and content addressable. In some embodiments, logic subsystem 502 and data-holding subsystem 504 may be integrated into one or more common devices, such as an application specific integrated circuit or a system on a chip.

FIG. 5 also shows an aspect of the data-holding subsystem in the form of removable computer-readable storage media 512, which may be used to store and/or transfer data and/or instructions executable to implement the herein described methods and processes. Removable computer-readable storage media 512 may take the form of CDs, DVDs, HD-DVDs, Blu-Ray Discs, EEPROMs, and/or floppy disks, among others.

It is to be appreciated that data-holding subsystem 504 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 500 that is implemented to perform one or more particular functions. In some cases, such a module, program, or engine may be instantiated via logic subsystem 502 executing instructions held by data-holding subsystem 504. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 506 may be used to present a visual representation of data held by data-holding subsystem 504. For example, display subsystem 506 may be a see-through display, as described above. As the herein described methods and processes change the data held by the data-holding subsystem, and thus transform the state of the data-holding subsystem, the state of display subsystem 506 may likewise be transformed to visually represent changes in the underlying data. Display subsystem 506 may include one or more display devices utilizing virtually any type of technology. Such display devices may be combined with logic subsystem 502 and/or data-holding subsystem 504 in a shared enclosure, or such display devices may be peripheral display devices.

When included, communication subsystem 508 may be configured to communicatively couple computing system 500 with one or more other computing devices. For example, communication subsystem 508 may be configured to communicatively couple computing system 500 to one or more other HMD devices, a gaming console, or another device. Communication subsystem 508 may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computing system 500 to send and/or receive messages to and/or from other devices via a network such as the Internet.

Sensor subsystem 510 may include one or more sensors configured to sense different physical phenomenon (e.g., visible light, infrared light, acceleration, orientation, position, etc.), as described above. For example, the sensor subsystem 510 may comprise one or more image sensors, motion sensors such as accelerometers, touch pads, touch screens, and/or any other suitable sensors. Therefore, sensor subsystem 510 may be configured to provide observation information to logic subsystem 502, for example. As described above, observation information such as image data, motion sensor data, and/or any other suitable sensor data may be used to perform such tasks as determining a particular gesture performed by the one or more human subjects.

In some embodiments, sensor subsystem 510 may include a depth camera (e.g., outward facing sensor 404 of FIG. 4A). The depth camera may include left and right cameras of a stereoscopic vision system, for example. Time-resolved images from both cameras may be registered to each other and combined to yield depth-resolved video.

In other embodiments, the depth camera may be a structured light depth camera configured to project a structured infrared illumination comprising numerous, discrete features (e.g., lines or dots). The depth camera may be configured to image the structured illumination reflected from a scene onto which the structured illumination is projected. Based on the spacings between adjacent features in the various regions of the imaged scene, a depth image of the scene may be constructed.

In other embodiments, the depth camera may be a time-of-flight camera configured to project a pulsed infrared illumination onto the scene. The depth camera may include two cameras configured to detect the pulsed illumination reflected from the scene. Both cameras may include an electronic shutter synchronized to the pulsed illumination, but the integration times for the cameras may differ, such that a pixel-resolved time-of-flight of the pulsed illumination, from the source to the scene and then to the cameras, is discernable from the relative amounts of light received in corresponding pixels of the two cameras.

In some embodiments, sensor subsystem 510 may include a visible light camera. Virtually any type of digital camera technology may be used without departing from the scope of this disclosure. As a non-limiting example, the visible light camera may include a charge coupled device image sensor.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of augmenting reality, the method comprising:
receiving first observation information of a first physical space from a first head-mounted display device, the first head-mounted display device including a first see-through display configured to visually augment an appearance of the first physical space to a user viewing the first physical space through the first see-through display;
receiving second observation information of a second physical space from a second head-mounted display device, the second head-mounted display device including a second see-through display configured to visually augment an appearance of the second physical space to a user viewing the second physical space through the second see-through display;
mapping a shared virtual reality environment to the first physical space and the second physical space based on the first observation information and the second observation information, the shared virtual reality environment including a virtual object;
sending first augmented reality display information to the first head mounted display, the first augmented reality display information configured to display the virtual object via the first see-through display with occlusion relative to a real world object from a perspective of the first see-through display.

2. The method of claim 1, where the first physical space and the second physical space are congruent, and where the first observation information is from a first perspective of the first see-through display and the second observation information is from a second perspective of the second see-through display, the first perspective being different than the second perspective.

3. The method of claim 2, where the shared virtual reality environment is mapped such that the virtual object appears to be located in a same physical space from both the first perspective and the second perspective.

4. The method of claim 1, where the first physical space and the second physical space are incongruent.

5. The method of claim 4, where the first augmented reality display information is configured to display within the shared virtual reality environment a second real world object that is physically present in the second physical space but not physically present in the first physical space.

6. The method of claim 1, where a mapped position of the real world object is between the virtual object and the first see-through display, and where the first augmented reality display information is configured to display only those portions of the virtual object that are not behind the real world object from the perspective of the first see-through display.

7. The method of claim 1, where a mapped position of the real world object is behind the virtual object from the perspective of the first see-through display, and where the first augmented reality display information is configured to display the virtual object with sufficient opacity so as to substantially block sight of the real world object through the first see-through display.

8. The method of claim 1, where mapping the shared virtual reality environment includes transforming a coordinate system of the first physical space from the perspective of the first see-through display and a coordinate system of the second physical space from a perspective of the second see-through display to a shared coordinate system.

9. The method of claim 1, where mapping the shared virtual reality environment includes transforming a coordinate system of the second physical space from a perspective of the second see-through display to a coordinate system of the first physical space from the perspective of the first see-through device.

10. The method of claim 1, further comprising sending second augmented reality display information to the second head mounted display, the second augmented reality display information configured to display the virtual object via the second see-through display with occlusion relative to the real world object from a perspective of the second see-through display.

11. The method of claim 1, where the first observation information is collected by a sensor subsystem of the first head mounted display device.

12. The method of claim 1, where the sensor subsystem includes a depth camera imaging the first physical space.

13. The method of claim 1, where the sensor subsystem includes a visible light camera imaging the first physical space.

14. The method of claim 1, where the shared virtual reality environment includes a surface reconstructed object, the surface reconstructed object originating from the first physical space or the second physical space, the surface reconstructed object having a mapped position within a shared coordinate system of the shared virtual reality environment.

15. A data-holding subsystem holding instructions executable by a logic subsystem to:
receive first observation information of a first physical space from a first head-mounted display device, the first head-mounted display device including a first see-through display configured to visually augment an appearance of the first physical space to a user viewing the first physical space through the first see-through display;
map a virtual reality environment to the first physical space based on the first observation information, the shared virtual reality environment including a virtual object;
send first augmented reality display information to the first head mounted display, the first augmented reality display information configured to display the virtual object via the first see-through display with occlusion relative to a real world object from a perspective of the first see-through display.

16. The system of claim 15, where a mapped position of the real world object is between the virtual object and the first see-through display, and where the first augmented reality display information is configured to display only those portions of the virtual object that are not behind the real world object from the perspective of the first see-through display.

17. The system of claim 15, where a mapped position of the real world object is behind the virtual object from the perspective of the first see-through display, and where the first augmented reality display information is configured to display the virtual object with sufficient opacity so as to substantially block sight of the real world object through the first see-through display.

18. The system of claim 15, where mapping the shared virtual reality environment includes transforming a coordinate system of the first physical space from the perspective of the first see-through display to a shared coordinate system.

19. The system of claim 15, where the first observation information is collected by a sensor subsystem of the first head mounted display device, the sensor subsystem including a depth camera imaging the first physical space.

20. A method of augmenting reality, the method comprising:
receiving first observation information of a first physical space from a first head-mounted display device, the first head-mounted display device including a first see-through display configured to visually augment an appearance of the first physical space to a user viewing the first physical space through the first see-through display;
receiving second observation information of a second physical space from a second head-mounted display device, the second head-mounted display device including a second see-through display configured to visually augment an appearance of the second physical space to a user viewing the second physical space through the second see-through display;
mapping a shared virtual reality environment to the first physical space and the second physical space based on the first observation information and the second observation information, the shared virtual reality environment including a virtual object, a mapped position of a first real world object in the first physical space being between the virtual object and the first see-through display from a perspective of the first see-through display and being behind the virtual object from a perspective of the second see-through display, a mapped position of a second real world object in the second physical space being between the virtual object and the second see-through display from a perspective of the second see-through display and being behind the virtual object from a perspective of the first see-through display;
sending first augmented reality display information to the first head mounted display, the first augmented reality display information configured to display only those portions of the virtual object that are not behind the first real world object from the perspective of the first see-through display and to display the virtual object blocking the second real world object; and
sending second augmented reality display information to the second head mounted display, the second augmented reality display information configured to display only those portions of the virtual object that are not behind the second real world object from the perspective of the second see-through display and to display the virtual object blocking the first real world object.
